(19) United States
(12) Patent Application Publication
(10) Pub. No.: US 2013/0182178 A1
(43) Pub. Date: Jul. 18, 2013

(54) RECORDING APPARATUS

(71) Applicant: SANYO ELECTRIC CO., LTD., Moriguchi City (JP)

(72) Inventor: Masahiro Shioji, Neyagawa City (JP)

(73) Assignee: SANYO ELECTRIC CO., LTD., Moriguchi City (JP)

(21) Appl. No.: 13/716,297

(22) Filed: Dec. 17, 2012

(30) Foreign Application Priority Data
Dec. 27, 2011 (JP) 2011-284582

(51) Int. Cl. H04N 5/232

(52) U.S. Cl. CPC H04N 5/23241
USPC 348/372

(57) ABSTRACT

A recording apparatus includes a detector detecting a voltage of a battery. A first sensing processor senses a recording operation. A recorder executes a recording process according to the recording operation. A second sensing processor senses a predetermined operation other than the recording operation. A processor executes a predetermined process according to the predetermined operation. A first controller executes the predetermined process when the predetermined operation is sensed during a time a power fed from the power feeding device is being received. A second controller prohibits the recording process if the voltage of the battery is smaller than a predetermined threshold value when the recording operation is sensed during a time the power fed from the power feeding device is being received, and executes the recording process if the voltage of the battery is equal to or more than the predetermined threshold value when the recording operation is sensed.

### CROSS REFERENCE OF RELATED APPLICATION

The disclosure of Japanese Patent Application No. 2011-284582, which was filed on Dec. 27, 2011, is incorporated herein by reference.

### BACKGROUND OF THE INVENTION

1. Field of the Invention

The present invention relates to a recording apparatus, and more particularly, relates to a recording apparatus which is provided with a power receiving portion for receiving a power fed from a power feeding device and which operates based on a power fed from the power feeding device or a power supplied from a battery.

2. Description of the Related Art

One example of this type of apparatus includes an information apparatus fed with a power from a USB, in which it is determined whether or not a battery is in an over-discharge state, and when it is determined that a current state is the over-discharge state, the battery is charged via a connected power source having a small power capacity, and after a main body is charged up to a voltage level enabling the main body to activate with the battery, the main body is activated with the battery.

However, in the above-described apparatus, it is not assumed that a recording process, etc., are executed in the main body apparatus based on the power supplied from an external power source. Naturally, there is not provided a countermeasure in any way against a situation where it is not possible any more to continue the recording process when the battery charge is insufficient due to a stop of the power supply from the external power source during the execution of the recording process.

### SUMMARY OF THE INVENTION

According to the present invention, a recording apparatus which is provided with a power receiving portion for receiving a power fed from a power feeding device and which operates based on the power supplied from a battery or the power feeding device, said apparatus comprises: a detector which detects a voltage of the battery; a first sensing processor which senses a recording operation; a recorder which executes a recording process according to the recording operation; a second sensing processor which senses a predetermined operation other than the recording operation; a processor which executes a predetermined process according to the predetermined operation; a first controller which executes the predetermined process when the predetermined operation is sensed by the second sensing processor during a time that a power fed from the power feeding device is being received; and a second controller which prohibits the recording process if the voltage of the battery is smaller than a predetermined threshold value when the recording operation is sensed by the first detector during a time that the power fed from the power feeding device is being received, and executes the recording process if the voltage of the battery is equal to or more than the predetermined threshold value when the recording operation is sensed by the first sensing processor.

According to the present invention, a recording apparatus which is provided with a power receiving portion for receiving a power fed from a power feeding device and which operates based on the power supplied from a battery or the power feeding device, said apparatus comprises: a first voltage detector which detects a fed voltage when an apparatus main body is fed with a power from a power feeding device; a second voltage detector which detects a voltage of the battery, a controller which controls the first voltage detector and the second voltage detector, wherein the controller controls so that detection of the voltage fed by the first voltage detector and detection of the voltage of the battery in the second voltage detector are executed when the apparatus main body is receiving the power fed from the power feeding device.

According to the present invention, a recording apparatus which is provided with a power receiving portion for receiving a power fed from a power feeding device and which operates based on the power supplied from a battery or the power feeding device, said apparatus causing a processor of a recording device to execute: a detecting step of detecting a voltage of the battery;

a first sensing step of sensing a recording operation; a recording step of executing a recording process according to the recording operation; a second sensing step of sensing a predetermined operation other than the recording operation;

a step of executing a predetermined process according to the predetermined operation; a first controlling step of executing the predetermined process when the predetermined operation is sensed by the second sensing step during a time that a power fed from the power feeding device is being received; and a second controlling step of prohibiting the recording process if the voltage of the battery is smaller than a predetermined threshold value when the recording operation is sensed by the first detecting step during a time that the power fed from the power feeding device is being received, and executing the recording process if the voltage of the battery is equal to or more than the predetermined threshold value when the recording operation is sensed by the first sensing step.

The above described characteristics and advantages of the present invention will become more apparent from the following detailed description of the embodiment when taken in conjunction with the accompanying drawings.

### BRIEF DESCRIPTION OF THE DRAWINGS

FIG. 1 is a block diagram showing one portion of a basic configuration of a circuit of a digital movie camera 1 according to one embodiment of the present invention;

FIG. 2 is a diagram showing a relationship between an internal voltage and an output voltage of a USB mobile power source 32 according to this embodiment, and a time period;

FIG. 3 is a flowchart showing one example of a procedure controlled by the digital movie camera 1 according to this embodiment; and

FIG. 4 is a flowchart showing another example of a procedure controlled by the digital movie camera 1 according to this embodiment.

### DETAILED DESCRIPTION OF THE PREFERRED EMBODIMENTS

Hereinafter, as one embodiment of a recording apparatus of the present invention, a mode in which a digital movie camera 1 is implemented is specifically described with reference to drawings.

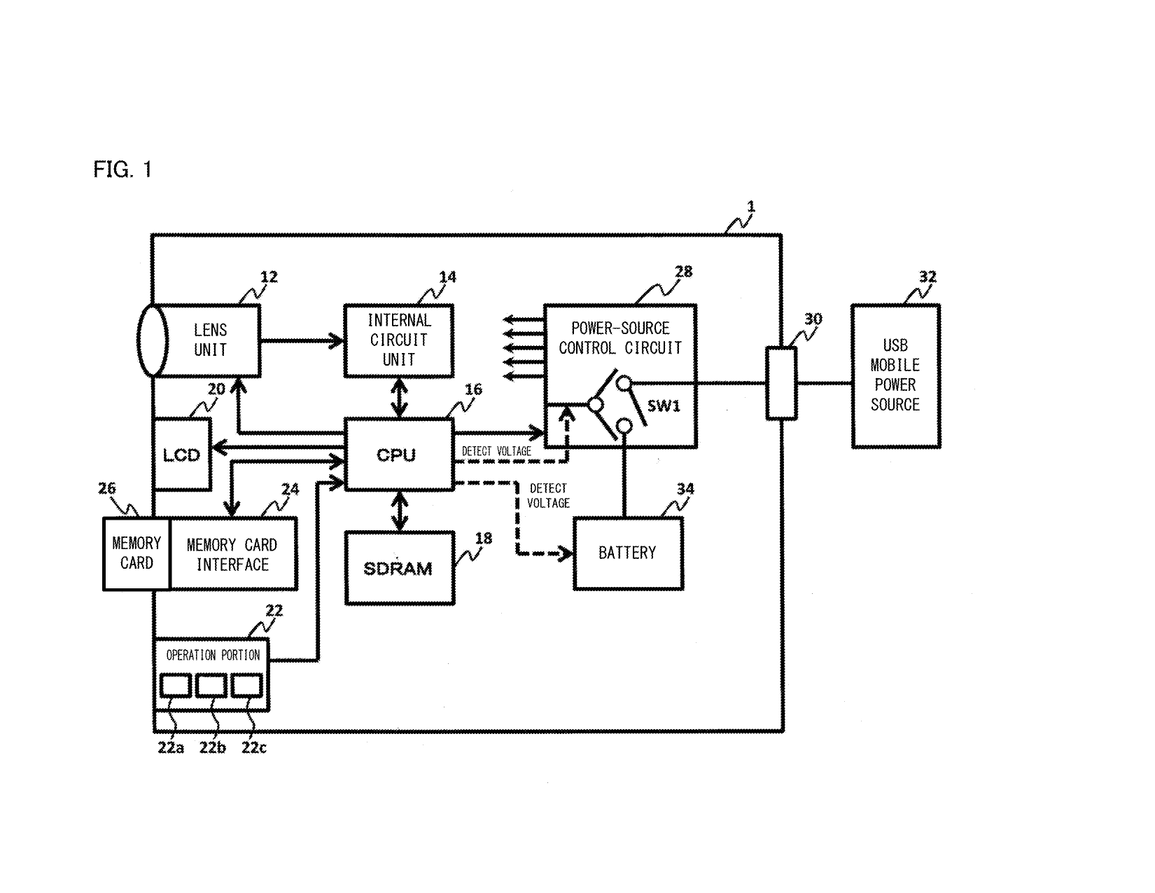

FIG. 1 shows a block diagram of the digital movie camera 1 of this embodiment. A lens unit 12 includes a lens group including an optical lens and an aperture, and is connected to an internal circuit unit 14 including a CMOS imager unit and a signal processing circuit. One frame of an optical image of a primary subject is taken into the internal circuit unit 14 through the lens unit 12. The lens unit 12, the internal circuit unit 14, and an SDRAM 8 are connected to a CPU 16.

Inside the internal circuit unit 14, various processes are performed on the taken optical image of the primary subject, and the resultant image is converted in one frame of a digital image signal in Y, U, and V formats. The converted digital image signal is stored in the SDRAM 18. Such a process in which the optical image of the primary subject is subjected to the various processes after which it is stored in the SDRAM 18 is defined as an imaging process.

It is possible to output the digital image signal stored in the SDRAM 18, by control of the CPU 16, to an LCD 20. The LCD 20 includes an LCD driver not shown, and the LCD driver converts the Y, U, and V signals into an RGB signal, and is capable of causing the LCD 20 to display an image based on the digital image signal. Thus, the process that lasts up to the digital image signal stored in the SDRAM 18 being displayed, as the image, on the LCD 20 is defined as a displaying process.

Moreover, as a result of the imaging process and the displaying process being sequentially repeated, a live view image is displayed on the LCD 20. It is noted that in this embodiment, a mode in which the LCD 20 is adopted as the monitor is described, however, a display device such as an organic EL may be adopted.

An operation portion 22 includes a menu operation portion 22a, a release operation portion 22b, and a mode-selection operation portion 22c, and may include a cursor key, etc.

When the menu operation portion 22a is operated, a menu screen is displayed on the LCD 20. A user selects a desired item, from among a plurality of items displayed on the menu screen. A desired value is set to the selected desired item. For example, as the desired item, when an “image size” is selected, a plurality of options of an aspect ratio (4:3, 16:9, etc.,) and an image size (4 M, 3 M, etc.) are displayed on the LCD 20, and when the user selects the desired value, the value is set to the image size.

When the mode-selection operation portion 22c is operated by a user, it is possible to select any one of a still-image photographing mode, a moving-image photographing mode, and a reproduction mode, which are some of a plurality of modes provided in the digital movie camera 1.

When the still-image photographing mode is selected as a result of the mode-selection operation portion 22c being operated, the live view image is displayed on the LCD 20. When the release operation portion 22b is operated by the user in a state where the live view image is being displayed on the LCD 20, the above-described imaging process is executed once, based on a resolution for a still image photograph.

The CPU 16 is connected to a memory card interface 24, and a memory card 26 is connected to the memory card interface 24. Depending on an operation on the release operation portion 22b, the memory card interface 24 is controlled so that a still image file is opened on the memory card 26 and a still-image temporary file for storing management information for creating the still image file is created on the memory card 26. The digital image signal stored in the SDRAM 18 is subjected to a compression process in a JPEG format, by the CPU 16, and the resultant signal is stored, as one frame of still-image compressed data, on the SDRAM 18.

Then, the CPU 16 stores the one frame of still-image compressed data into the still image file, and when the still image file is closed by using the management information stored in the still-image temporary file, the still image file is created on the memory card 26.

When the moving-image photographing mode is selected by the mode-selection operation portion 22c, the live view image is displayed on the LCD 20.

When the release operation portion 22b is operated by the user in a state where the live view image is being displayed on the LCD 20 thereby to instruct to start photographing a moving image, the above-described imaging process is sequentially executed, based on a resolution for photographing a moving image. Depending on the operation on the release operation portion 22, the CPU 16 controls the memory card interface 24 so that a moving image file is opened on the memory card 26 and a moving-image temporary file is created on the memory card 26. The moving-image temporary file stores therein write information of the compressed moving image data, synchronization information between the compressed moving image data and compressed audio data, when there is compressed audio data, and information such as a date, which are management information for creating the moving image file. The plurality of digital image signals stored in the SDRAM 18 are subjected to a compression process in the MPEG4 format by the CPU 16, and the compressed moving image data is again stored in the SDRAM 18. Then, the compressed moving image data is sequentially stored into the moving image file of the memory card 26.

Until it is instructed to end the moving image photograph, the above-described process is repeated. Examples of the instruction to end the moving image photograph include the release operation portion 22b being operated, or an end instruction by the CPU 16 itself due to an insufficient remaining amount of a battery 34. When the instruction to end the moving image photograph is applied, the CPU 16 executes a moving-image photograph ending process on the moving image file by using the management information for creating the moving image file stored in the moving-image temporary file, in order to end the moving image photograph. Specifically, the compressed moving image data and the compressed audio data are made to synchronize each other upon reproduction, a recording time of the moving image file is recorded, and header information is updated. When the moving-image photograph ending process is executed, the moving image file is recorded normally in the memory card 26, and this allows the CPU 16 to recognize the moving image file upon reproduction.

When the reproduction mode is selected by the mode-selection operation portion 22c, and a desired still image file or moving image file is selected, the CPU 16 controls the memory card interface 24 so that the still image file or the moving image file is reproduced from the memory card 26. A reproducing process includes a process in which the selected file is decompressed and the processed image is displayed as an image on the LCD 20.

It is noted that the digital movie camera 1 is provided with a power-source control circuit 28. The power-source control circuit 28 is connected, via a USB terminal 30 that functions also as an external power-source terminal, to a USB mobile power source 32. Furthermore, the power-source control circuit 28 is connected to the battery 34. The power-source control circuit 28 is provided with a switch SW1, and the switch SW1 is switched between the USB mobile power source 32 and the battery 34, as a target to which a power is supplied, during the operation of the digital movie camera 1.

When the digital movie camera 1 is connected to the USB mobile power source 32, the digital movie camera 1 is operated by using the power supplied from the USB mobile power source 32, while charging the battery 34 by using the power supplied from the USB mobile power source 32. When the digital movie camera 1 is not connected to the USB mobile power source 32 or not fed with the power from the USB mobile power source 32, the digital movie camera 1 is operated by the power supplied from the battery 34.

It is noted that when the battery 34 is fully charged, or when the power from the USB mobile power source 32 stops, the connection between the USB mobile power source 32 and the battery 34 is released.

The CPU 16 is also connected to the power-source control circuit 28 and the battery 34, and is configured to be capable of detecting the voltage in the power supplied from the USB mobile power source 32 and the voltage corresponding to the remaining amount of the battery 34.

It is noted that although in this embodiment, the USB mobile power source 32 is adopted as the target to which the power from the digital movie camera 1 is supplied, the power may be supplied by connecting a USB AC adaptor to the USB terminal 30. In this case, when this embodiment is applied to an accident in which the connection of the AC adaptor is suddenly released, it is possible to prevent an error from occurring in the recording process.

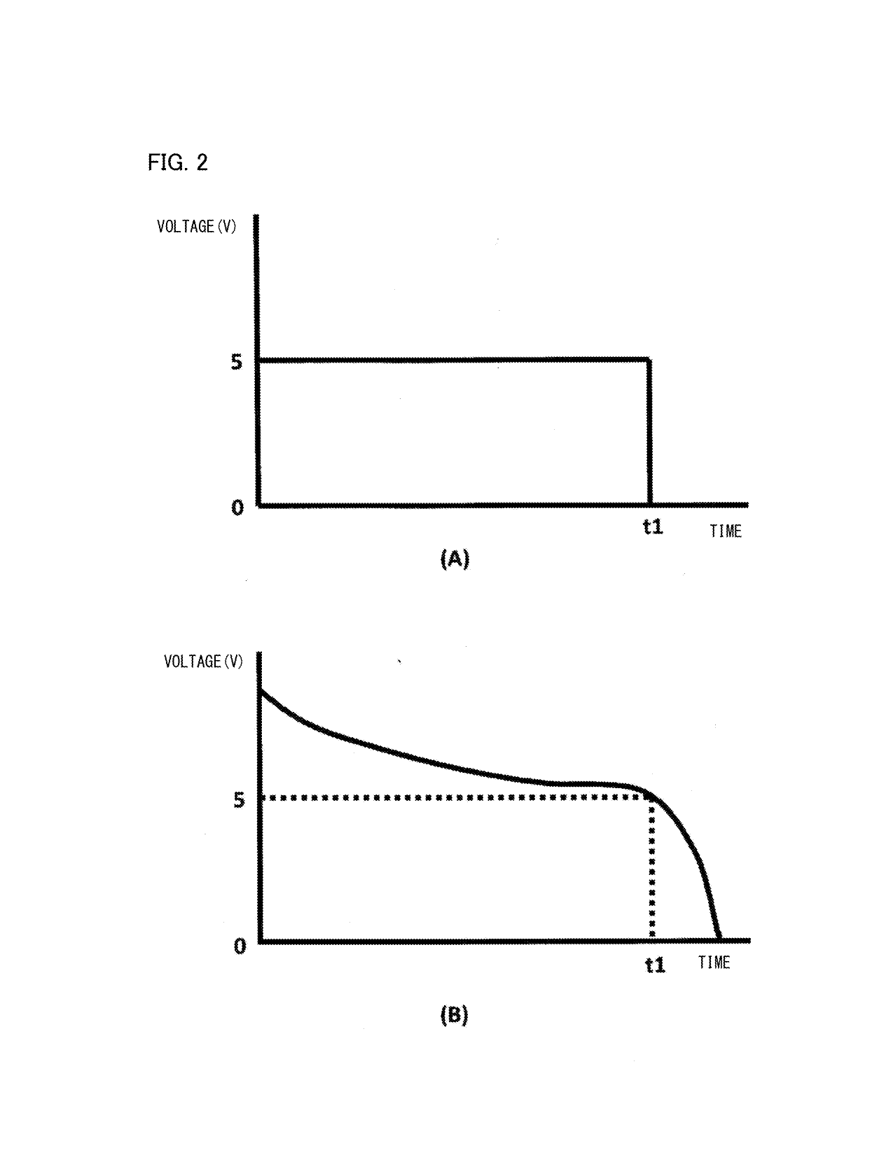

FIG. 2(A) shows a characteristic of an output voltage to the digital movie camera 1 of the USB mobile power source 32, and FIG. 2(B) shows a characteristic of an internal voltage of the USB mobile power source 32.

As shown in FIG. 2(A), the output voltage of the USB mobile power source 32 is such that, if the power is continuously supplied to the digital movie camera 1, then the output voltage reaches 0 at a time point t1, resulting in a sudden stop of power feeding. This occurs because, as shown in FIG. 2(B), if the power is continuously supplied to the digital movie camera 1, then the internal voltage of the USB mobile power source 32 falls below a prescribed voltage for outputting 5V at the time point t1. However, although the CPU 16 is capable of detecting the output voltage of the USB mobile power source 32, the CPU 16 is not capable of detecting the internal voltage of the USB mobile power source 32, and therefore, it is necessary to introduce a measures against a case where the power is suddenly not fed any more.

Accordingly, when the connection between the digital movie camera 1 and the USB mobile power source 32 is released, or when the power is suddenly not fed any more to the digital movie camera 1, and as a result, a power-feeding source is switched so that the power is fed from the battery 34 to the digital movie camera 1, if the remaining amount of the battery 34 is insufficient, then there occurs an error that it is not possible to continue the operation of the digital movie camera 1. A specific case is as follows: when connection of the USB mobile power source 32 is released during the moving image photograph, or when the power is suddenly not fed any more, and the remaining amount of the battery 34 is insufficient, the power for operating the digital movie camera 1 is insufficient, probably resulting in a case where the moving image file on the memory card 26 is lost. That is, the moving-image photograph ending process is not performed normally, and as a result, the CPU 16 may not be able to recognize the moving image file.

Therefore, in the digital movie camera 1 of this embodiment, the CPU 16 executes the following control in order to avoid the above-described situation.
(1) In a case where the power is supplied from the USB mobile power source 32 and the remaining amount of the battery 34 is insufficient, an operation other than the moving image photograph (a reproduction, a menu setting, etc.) is allowed to operate.
(2) In a case where the power is supplied from the USB mobile power source 32 and the remaining amount of the battery 34 is insufficient if a moving-image photograph starting operation is performed by the release operation portion 22b being operated, a message, an icon, or a symbol indicating that the remaining amount of the battery 34 is insufficient is displayed on the LCD 20, and the moving image photograph is not performed.
(3) In a case where the power is supplied from the USB mobile power source 32 and the remaining amount of the battery 34 is insufficient, the moving image photograph is enabled at a time point when the voltage of the battery 34 exceeds a threshold value.
(4) In a case where the remaining amount of the battery 34 is decreased during the moving image photograph, the moving-image photograph ending process is performed even if the USB mobile power source 32 is connected.

In the preceding (4), it is noted that a reason why the remaining amount of the battery 34 is decreased during the moving image photograph may be that, as a result of an optical lens moving or an operation such as a still image photograph being frequently performed, a power consumption becomes higher than the power supplied from the USB mobile power source 32, resulting in a decrease in remaining amount of the battery 34.

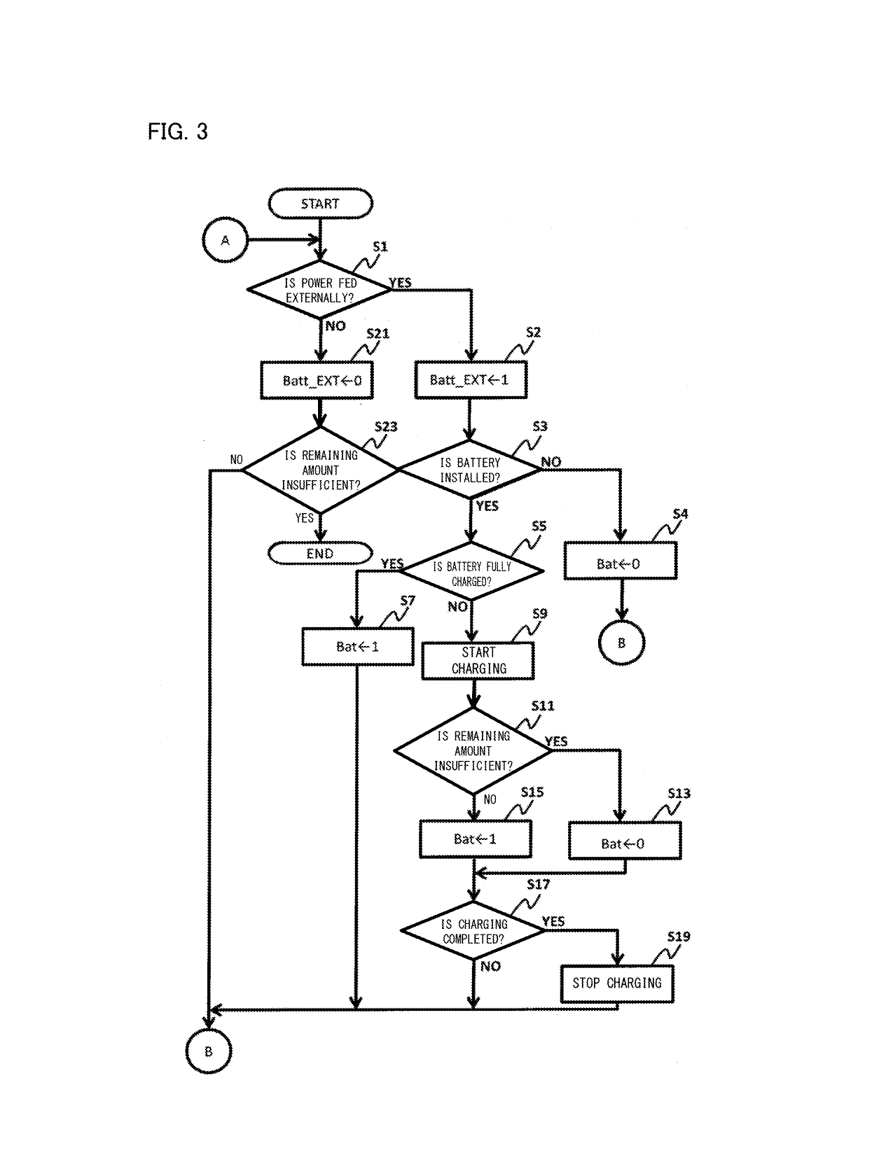

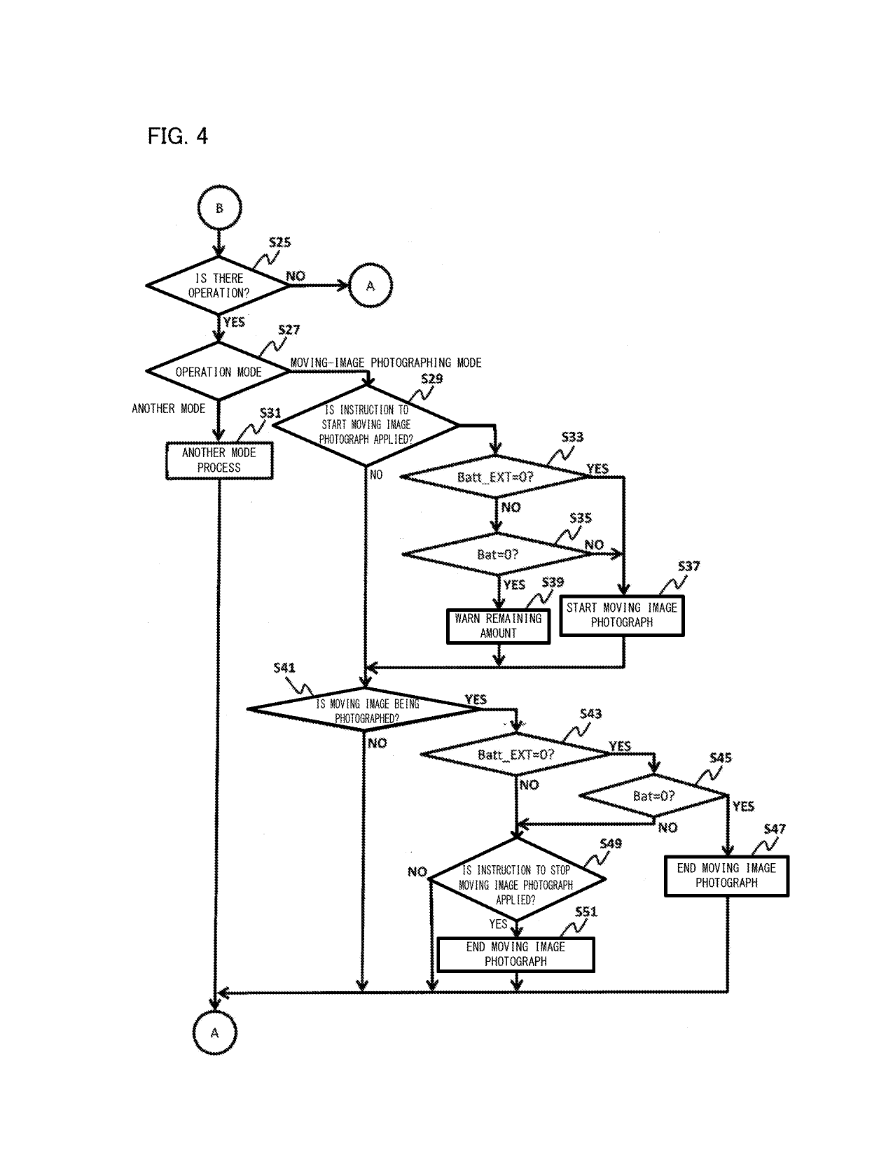

Subsequently, by using flowcharts shown in FIG. 3 and FIG. 4, a procedure executed by the CPU 16, including the above-described control operations (1) to (4), is described. These processes are realized as a result of the CPU 16 executing a program stored in a flash memory not shown.

When a power source is turned on, in a step S1, it is determined whether or not the power is externally fed. When YES is determined in the step S1, that is, when the power is fed from USB mobile power source 32, the process proceeds to a step S2 so as to raise a power supply source flag (Batt_EXT<−1). Next, the process proceeds to a step S3 so as to determine whether or not the battery 34 is installed. When YES is determined in the step S3, the process proceeds to a step S5, and when NO is determined, the process proceeds to a step S4. In the step S4, the battery flag is lowered (BAT<−0), and the process proceeds to a step S25.

In the step S5, it is determined whether or not the battery 34 is fully charged. That is, it is determined whether or not the voltage of the battery 34 satisfies a predetermined value. When YES is determined, the process proceeds to a step S7 so as to raise a battery flag (BAT<−1). When NO is determined in the step S5, the process proceeds to a step S9 so as to cause the battery 34 to start charging. Subsequently, the process proceeds to a step S11 so as to determine whether or not the remaining amount of the battery 34 is insufficient. That is, it is determined whether or not the voltage of the battery 34 falls below a threshold value.

In the step S11, when it is determined that the remaining amount of the battery 34 is insufficient, the process proceeds to a step S13 so as to lower the battery flag (BAT<−0). On the other hand, in the step S11, when it is determined that the remaining amount of the battery 34 is not insufficient, the process proceeds to a step S15 so as to raise the battery flag (BAT<−1).

After the processes in the steps S13 and S15, the process proceeds to a step S17 to determine whether or not the battery 34 completes charging, that is, to determine whether not the voltage of the battery 34 satisfies the predetermined value, and when YES is determined, the process proceeds to a step S19 so as to control the power-source control circuit 28 so that charging the battery 34 is stopped.

Then, when No is determined in the step S17, and after the process in the step S7, the process proceeds to the step S25.

When NO is determined in the step S1, that is, when the power is not fed from the USB mobile power source 32, the process proceeds to a step S21 so as to lower the power supply source flag (Batt_EXT <−0). Examples of a case where it is determined that the power is not fed externally include a case where, in this embodiment, the power is not fed from the USB mobile power source 32, that is, a case where the USB mobile power source 32 and the digital movie camera 1 are not connected, or a case where the power supplied from the USB mobile power source 32 is stopped.

Subsequently, the process proceeds to a step S23 to determine whether or not the reaming amount of the batter 34 is insufficient. When YES is determined, the present procedure is ended.

When NO is determined in the step S23, the process proceeds to the step S25 in which an operation key scanning process is performed to determine whether or not the operation portion 22 is operated. When NO is determined in the step S25, that is, it is determined that the operation portion 22 is not operated, the process returns to the step S1. When YES is determined in the step S25, that is, when it is determined that the operation portion 22 is operated, the process proceeds to a step S27 so as to determine the operation mode.

Herein, when the moving-image photographing mode is selected by the mode-selection operation portion 22c, the moving-image photographing mode is determined in the step S27, and the process proceeds to a step S29. On the other hand, when the still-image photograph mode or the reproduction mode is selected by the mode-selection operation portion 22c or when the menu operation portion 22a is operated, the process proceeds to a step S31 so as to execute a process corresponding to the selected mode, and then, the process returns to the step S1. Herein, the description for the process for the selected mode will be omitted.

In the step S29, it is determined whether or not an instruction to start the moving image photograph is applied, based on the release operation portion 22b being operated. When NO is determined, the process proceeds to a step S41, and when YES is determined, the process proceeds to a step S33. In the step S33, it is determined whether or not the supply source flag is lowered (Batt_EXT =0?). When YES is determined in the step S33, or when the power is not fed from the USB mobile power source 32, the process proceeds to a step S37 so as to start the moving image photograph. This is because when the remaining amount of the battery 34 is insufficient in the step S23, the present procedure has been ended, and thus, when the process has entered the step S37, it is possible to perform the moving image photograph because the remaining amount of the battery 34 is not insufficient.

When NO is determined in the step S33, that is, when the power is fed from the USB mobile power source 32, the process proceeds to a step S35 so as to determine whether or not the battery flag is lowered (BAT=0?). When NO is determined in this step, that is, when the remaining amount of the battery 34 is large, the process proceeds to the step S37 so as to start the moving image photograph, and then, the process proceeds to the step S41.

When YES is determined in the step S35, that is, when the remaining amount of the battery 34 is insufficient, the process proceeds to a step S39 so as to warn the user by, for example, displaying on the LCD 20, a message, an icon, or an symbol indicating that the remaining amount of the battery 34 is insufficient, and then, the process proceeds to the step S41.

In this way, when the power is fed from the USB mobile power source 32, and when the remaining amount of the battery 34 is insufficient, a warning about the remaining amount of the battery 34 is issued and the moving image photograph is not started.

In the step S41, it is determined whether or not the current situation is a situation where the moving image is being photographed. When NO is determined in the step S41, the process returns to the step S1, and when YES is determined, the process proceeds to a step S43. In the step S43, it is determined whether or not the supply source flag is lowered (Batt_EXT =0?). When YES is determined in the step S43, that is, when the power is not fed from the USB mobile power source 32, the process proceeds to a step S45 so as to determine whether or not the battery flag is lowered (BAT=0?).

When YES is determined in the step S45, that is, when the remaining amount of the battery 34 is insufficient, the process proceeds to a step S47 so as to end the moving image photograph, and then, the process returns to the step S1.

When YES is determined in the step S43, and when NO is determined in the step S45, the process proceeds to a step S49 so as to determine whether or not an operation for ending the moving image photograph is performed based on the release operation portion 22b being operated. When NO is determined in the step S49, the process returns to the step S1, and when YES is determined, the process proceeds to a step S51 so as to end the moving image photograph, and then, the process returns to the step S1.

Thus, the moving image photograph is ended if there is a possibility that even when the USB mobile power source 32 is connected, the remaining amount of the battery 34 is decreased during the moving image photograph so that the power insufficient state may ensue.

As described above, the digital movie camera 1 according to this embodiment operates by using the power supplied from the USB mobile power source 32.

In a case where the operation for the moving image photograph is performed in a state where the USB mobile power source 32 is connected, if the remaining amount of the battery 34 is insufficient, a message indicating an insufficient remaining amount of the battery 34 is displayed on the LCD 20, rather than executing the moving image photograph. Therefore, when the power is supplied only from the battery 34 to the digital movie camera 1 as a result of a sudden connection release of the USB mobile power source 32 or a sudden stop of power supplied from the USB mobile power source 32, it is possible to avoid a deletion of a moving-image photograph file that could occur as a result of the digital movie camera 1 not being able to operate due to an insufficient remaining amount of the battery 34.

Furthermore, the start of the moving image photograph is accepted at a time point when the charge level of the battery 34 is sufficient, and thus, it is possible for the user to photograph without worries.

Moreover, there is a case where when the remaining amount of the battery 34 is decreased during the photograph, the power is supplied only from the battery 34 to the digital movie camera 1 as a result of a sudden connection cancellation of the USB mobile power source 32 or a sudden stop of power from the USB mobile power source 32, even if the power is supplied from the USB mobile power source 32. In this case, if the moving-image photograph ending process is performed, it is still possible to avoid a deletion of a moving-image photograph file that could occur as a result of the digital movie camera 1 not being able to operate due to an insufficient remaining amount of the battery 34.

It is noted that in this embodiment, the above-described control operation (4) is performed in the CPU 16; however, when the remaining amount of the battery 34 is decreased during the moving image photograph, it may be possible to issue a warning, for example, indicating the remaining amount of the battery 34 to the user, even when the USB mobile power source 32 is connected, rather than performing the moving-image photograph ending process.

Moreover, in this embodiment, in the step S39, the notification is issued, which displays a message or a symbol on the LCD 20, for example, in order to warn the user of the insufficiency of the remaining amount of the battery 34; however, a speaker may be provided so as to notify with voice.

Furthermore, in this embodiment, as a result of execution of a program stored in the flash memory not shown in the digital movie camera 1, the above-described procedure is executed; however, the above-described procedure may be executed by executing a program downloaded from outside.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A recording apparatus which is provided with a power receiving portion for receiving a power fed from a power feeding device and which operates based on the power supplied from a battery or the power feeding device, said apparatus comprising:
a detector which detects a voltage of the battery,
a first sensing processor which senses a recording operation;
a recorder which executes a recording process according to the recording operation;
a second sensing processor which senses a predetermined operation other than the recording operation;
a processor which executes a predetermined process according to the predetermined operation;
a first controller which executes the predetermined process when the predetermined operation is sensed by said second sensing processor during a time that a power fed from the power feeding device is being received; and
a second controller which prohibits the recording process if the voltage of the battery is smaller than a predetermined threshold value when the recording operation is sensed by said first detector during a time that the power fed from the power feeding device is being received, and executes the recording process if the voltage of the battery is equal to or more than the predetermined threshold value when the recording operation is sensed by said first sensing processor.

2. A recording apparatus according to claim 1, wherein said second controller includes a notifier which notifies to outside, if the voltage of the battery is smaller than a predetermined threshold value when the recording operation is sensed by said first sensing processor during reception of the power fed from the power feeding device.

3. A photographing apparatus according to claim 2, further comprising a stopper which stops the recording process if the voltage, of the battery, detected by said detector during execution of the recording process is smaller than a predetermined threshold value.

4. A recording apparatus according to claim 1, wherein the recording process includes a process for recording acquisition data, as a file, on a recorder, and for recording management information of the file.

5. A recording apparatus according to claim 4, wherein the acquisition data is photograph data acquired by a photographing processor.

6. A recording apparatus which is provided with a power receiving portion for receiving a power fed from a power feeding device and which operates based on the power supplied from a battery or the power feeding device, said apparatus comprising:
a first voltage detector which detects a fed voltage when an apparatus main body is fed with a power from a power feeding device;
a second voltage detector which detects a voltage of the battery,
a controller which controls said first voltage detector and said second voltage detector, wherein
said controller controls so that detection of the voltage fed by said first voltage detector and detection of the voltage of the battery in said second voltage detector are executed when the apparatus main body is receiving the power fed from the power feeding device.

7. A recording apparatus which is provided with a power receiving portion for receiving a power fed from a power feeding device and which operates based on the power supplied from a battery or the power feeding device, said apparatus causing a processor of a recording device to execute:
a detecting step of detecting a voltage of the battery;
a first sensing step of sensing a recording operation;
a recording step of executing a recording process according to the recording operation;
a second sensing step of sensing a predetermined operation other than the recording operation;
a step of executing a predetermined process according to the predetermined operation;
a first controlling step of executing the predetermined process when the predetermined operation is sensed by said second sensing step during a time that a power fed from the power feeding device is being received; and
a second controlling step of prohibiting the recording process if the voltage of the battery is smaller than a predetermined threshold value when the recording operation is sensed by said first detecting step during a time that the power fed from the power feeding device is being received, and executing the recording process if the voltage of the battery is equal to or more than the predetermined threshold value when the recording operation is sensed by said first sensing step.
